(19) United States
(12) Patent Application Publication
(10) Pub. No.: US 2002/0184632 A1
(43) Pub. Date: Dec. 5, 2002

(54) Computer peripheral device for web-enhanced media services

(76) Inventor: Glenn A. Reitmeier, Yardley, PA (US)

Correspondence Address: STEVE MENDELSOHN, MENDELSOHN & ASSOCIATES, P.C ., 1515 MARKET STREET, SUITE 715, PHILADELPHIA, PA, 19102, US

(21) Appl. No.: 09/870,310

(22) Filed: May 30, 2001

(51) Int. Cl. G06F 3/00; H04N 5/445; G06F 13/00; H04N 7/16; H04N 5/45

(52) U.S. Cl. 725/47; 725/139; 725/51; 348/565

(57) ABSTRACT

A peripheral device that can be configured, for example, in a personal computer (PC) system, between the PC processor and the PC monitor. The peripheral device receives video signals from the PC processor for display on the PC monitor. In addition, the peripheral device receives television (TV) signals from a TV source, for example, via a standard TV connection. The peripheral device combines the video content of the TV signals with the video signals received from the PC processor to generate a combined video signal for display on the PC monitor. The peripheral device supports web-based applications where the web-page layout is received by the PC system via a conventional Internet connection, where the peripheral device overlays the video content of the TV signals over appropriate corresponding windows in the web-page layout. In this way, bandwidth in the PC's Internet connection does not have to be used for streaming media delivery of TV video content. Display of the combined video signal on a PC monitor provides video quality advantages over WebTV technology, which displays combined video signals on lower-resolution TV sets. Moreover, implementation as a peripheral device provides installation advantages over PC-based tuner card technology, which requires installation inside the PC tower.

### BACKGROUND OF THE INVENTION

1. Field of the Invention

The present invention relates to computers, and, in particular, to peripheral devices for personal computers.

2. Description of the Related Art

In conventional web-based communications using a personal computer (PC), all signals are transmitted between the PC and the web via an Internet connection. When the Internet connection is based on a conventional modem, the bandwidth is typically about 56 kilobits per second (kbps). Such a low bandwidth severely restricts the ability to download high-quality audio/video streams for real-time rendering of the audio content by the PC speakers and display of the video content on the PC monitor, such as those streams associated with streaming media delivery of television (TV) content. Even with broadband connections of several hundred kbps, audio and video quality is still lower than that achieved by conventional TV sets playing either analog or digital TV signals.

PC-based tuner cards can bring either analog or digital TV signals directly into the PC, but such solutions require relatively complex installation (e.g., inside the PC's enclosure also referred to as the PC tower) that limits the potential market for such devices. WebTV relies on a set-top box to merge computer-generated video signals with TV signals for display on a conventional TV set, but the video resolution of TV sets is typically lower than that of PC monitors.

### SUMMARY OF THE INVENTION

The present invention is directed to a technique for merging computer-generated signals, such as the video signals corresponding to web-page layouts, with, for example, television video signals received directly from a TV source, for display on a computer monitor. The present invention may be implemented as a peripheral device for a computer system, such as a PC, that is configurable between the computer processor (e.g., located inside the PC tower) and the computer monitor. Since, in this implementation, the present invention is a peripheral device, it is much easier to install than a PC-based tuner card that needs to be installed inside the PC tower. Moreover, since the TV audio and video signals are provided by a conventional high-bandwidth TV connection, transmission bandwidth over the Internet connection does not have be “wasted” on streaming media delivery of television content. The result is the display of high-quality TV video signals on a high-resolution PC monitor and the rendering of high-quality TV audio signals on PC speakers without requiring a high-bandwidth Internet connection.

According to one embodiment, the present invention is a computer peripheral device configurable between a computer processor and a computer monitor, the device comprising (a) a video input interface configured to receive a digital video signal from the computer processor; (b) a television (TV) interface configured to receive at least one TV signal from a TV source; (c) a device processor configured to combine the digital video signal and a TV video signal from each TV signal to generate a combined digital video signal; and (d) a video output interface configured to transmit the combined digital video signal to the computer monitor.

According to another embodiment, the present invention is, at a web site server in a computer network, a computer-implemented method comprising the steps of (a) generating signals corresponding to a web site supported by the web site server; and (b) transmitting the signals from the web site server to a computer processor in the computer network, wherein the signals comprise (1) a digital video signal corresponding to the web site; and (2) instructions for implementation by the computer processor for coordinating combination of the digital video signal corresponding to the web site with at least one TV signal from a TV source into a combined digital video signal.

### BRIEF DESCRIPTION OF THE DRAWINGS

Other aspects, features, and advantages of the present invention will become more fully apparent from the following detailed description, the appended claims, and the accompanying drawings in which:

FIG. 1 shows a block diagram of the hardware configuration for a personal computer system, according to one embodiment of the present invention;

FIG. 2 shows a block diagram of the video processing performed by the device processor of the peripheral device of FIG. 1, according to one embodiment of the present invention; and

FIG. 3 shows a flow diagram of the processing of the PC system of FIG. 1 configured with the PC peripheral device, according to one possible mode of operation.

### DETAILED DESCRIPTION

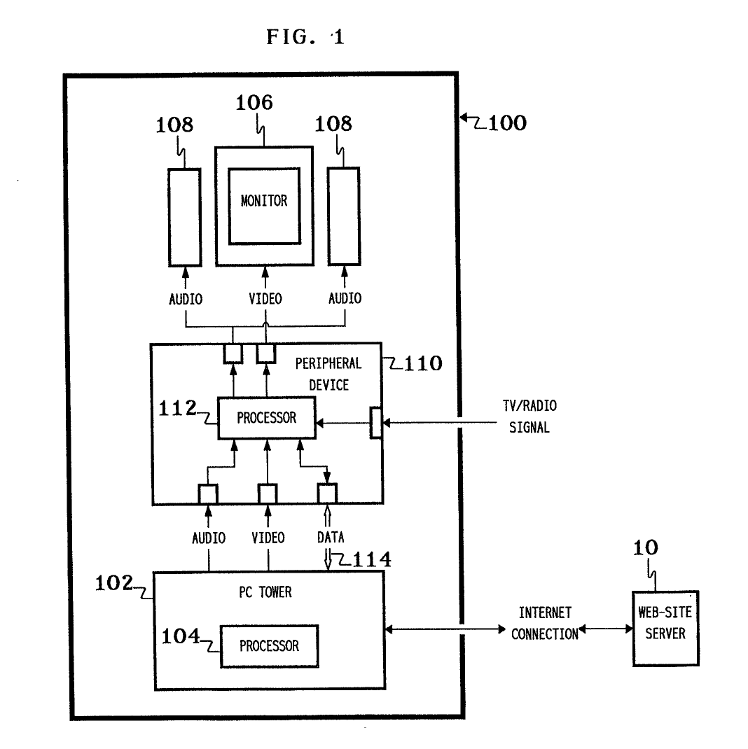

FIG. 1 shows a block diagram of the hardware configuration for a personal computer system 100, according to one embodiment of the present invention. PC system 100 comprises a conventional PC tower 102 having a conventional PC processor 104, a conventional PC monitor 106, and conventional PC speakers 108 configured with PC peripheral device 110 of the present invention having device processor 112. In one possible configuration, monitor 106 physically rests on top of peripheral device 110, which in turn physically rests on top of tower 102. Of course, other physical configurations are possible, and the present invention is not limited to any particular physical configuration.

In addition to device processor 112, peripheral device 110 has six interfaces (listed counter-clockwise started from the lower-left corner in FIG. 1):

(1) an audio input interface that enables peripheral device 110 to be connected to PC tower 102 using the same type of connection conventionally used to connect a PC tower directly to PC speakers,

(2) a video input interface that enables peripheral device 110 to be connected to PC tower 102 using the same type of connection conventionally used to connect a PC tower directly to a PC monitor,

(3) a data interface that enables peripheral device 110 to be connected to PC tower 102 using a standard data connection 114 (e.g., a universal serial bus (USB) or serial port (SP) connection),

(4) a TV/radio interface that enables peripheral device 110 to be connected to an (analog or digital) TV source, e.g., using a conventional cable TV connector or TV antenna connector, or to a radio source, e.g., using a conventional radio antenna,

(5) a video output interface that enables peripheral device 110 to be connected to PC monitor 106 using the same type of connection conventionally used to connect a PC tower directly to a PC monitor, and

(6) an audio output interface that enables peripheral device 110 to be connected to PC speakers 108 using the same type of connection conventionally used to connect a PC tower directly to PC speakers.

When configured in its TV mode (as opposed to its radio mode) of operation, device processor 112 can receive from PC processor 104 audio signals via the audio input interface and video (e.g., VGA) signals via the video input interface. Device processor 112 can also communicate with PC processor 104 via standard data connection 114. In addition, device processor 112 can receive one or more analog or digital TV signals (via the TV interface) from a TV source (not shown), which could be, for example, a terrestrial wireless, CATV, or DBS TV source. Device processor 112 can combine the one or more TV video signals from the TV source with the digital video signal from PC processor 104 to generate a combined digital video signal in which each TV video signal appears in a corresponding window in the layout of the digital video signal from PC processor 104. Device processor 112 can transmit the combined digital video signal (via the video output interface) for display on monitor 106. In addition, device processor 112 can combine one (or more) of the TV audio signals from the TV source with any audio signals received from PC processor 104 and transmit the resulting (e.g., stereo) combined audio signals (via the audio output interface) for rendering by PC speakers 108.

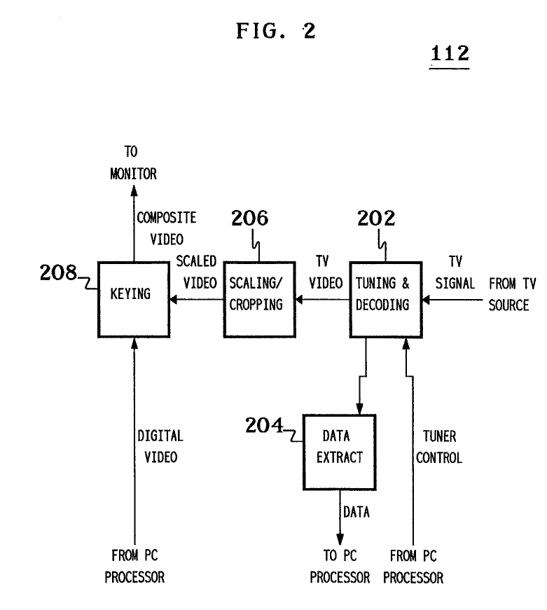

FIG. 2 shows a block diagram of the video processing performed by device processor 112 of peripheral device 110 of FIG. 1, according to one embodiment of the present invention. Depending on the particular implementation of device processor 112, the processing indicated in FIG. 2 is implemented in either hardware or software or a combination of both.

As indicated in FIG. 2, each TV signal received from the TV source is tuned and decoded at block 202. For analog TV signals, the processing of block 202 would include analog-to-digital (A/D) conversion. In some implementations, the TV signals may be encoded with certain data that is extracted at block 204 and transmitted to PC processor 104 of FIG. 1 via data connection 114. For analog TV signals, such as NTSC signals, the data can be encoded as vertical blanking interval (VBI) data. For digital TV signals, such as DTV signals, the data can be encoded as auxiliary data. Additionally, device processor 112 can receive tuner control signals from PC processor 104 via data connection 114 that are used to control the tuning process of block 202. The dimensions of the decoded digital TV video signals are modified (e.g., by scaling and/or cropping) at block 206 and the resulting modified TV video signals are then combined at block 208 with the digital video signals received from PC processor 104 to generate the combined digital video signal that is transmitted for display on PC monitor 106 of FIG. 1.

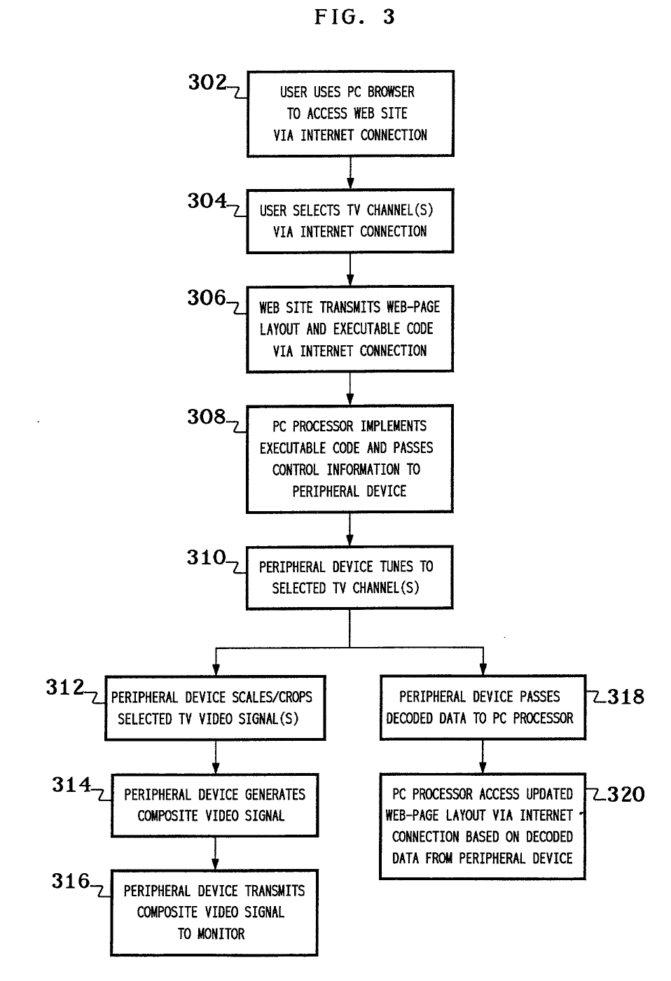

FIG. 3 shows a flow diagram of the processing of PC system 100 of FIG. 1 configured with PC peripheral device 110, according to one possible mode of operation. In this operating mode, the PC user uses a conventional web browser application implemented on PC processor 104 to access, via the PC's conventional Internet connection, a web site supported by web-site server 10 of FIG. 1 and specially designed to support the enhanced TV services of the present invention (step 302 of FIG. 3). Using the browser, the user selects, via the Internet connection, the one or more TV channels he/she wishes to watch (step 304). The web site transmits to the PC, via the Internet connection, HTML data for the layout of the web page and an appropriate Java script or other executable code for implementation on PC processor 104 (step 306).

When implemented on PC processor 104, this executable code causes processor 104 to pass appropriate control information to device processor 112 of peripheral device 110 via data connection 114 of FIG. 1 (step 308). The control information identifies the one or more selected TV channels as well as identifying a window in the web-page layout for the video content of each TV channel. The information for tuning to the appropriate TV channels may be based on zip code or other predetermined information about the PC user. In one implementation, each window is identified by specifying the location (e.g., X and Y coordinates of the upper left-hand corner) and size (X and Y dimensions) of the window. In an alternative implementation, each different window is identified by a different keying signal such as a specific color and/or texture, where, for each selected TV channel, the web-page layout has a window having the corresponding color or texture.

At block 202 of FIG. 2, device processor 112 uses the channel information received from PC processor 104 to tune to the one or more selected TV channels (step 310). At block 206 of FIG. 2, device processor 112 appropriately scales and/or crops each selected TV video signal for display in the corresponding window in the web-page layout (step 312). Again, depending on the particular implementation, the appropriate scaling/cropping is determined either from the specified dimensions of the corresponding window or by device processor 112 automatically determining the size of the window having the corresponding keying signals by analyzing the web-page layout in the digital video signals received from PC processor 104.

At block 208 of FIG. 2, device processor 112 overlays the one or more scaled and/or cropped TV video signals over the corresponding windows in the web-page layout to generate the combined digital video signal (step 314) and transmits the combined digital video signal for display on PC monitor 106 (step 316).

In some implementations, the selected TV signal(s) may be encoded with data for updating the web-page layout. In that case, at block 204 of FIG. 2, device processor 112 extracts such data from the received TV signal(s) and passes that data to PC processor 104 via data connection 114 (step 318) for use by the browser to access updated web-page layout information (step 320). Depending on the implementation, this data may correspond to ATVEF (Advanced TV Enhancement Forum) protocols or even simple Universal Resource Locators (URLs). In this way, the entire web-page layout can be synchronized with the video content of the selected TV channel(s).

The following characteristics apply to the implementation described in the context of FIG. 3:

The user launches the web-browsing session using the PC's browser application executed on PC processor 104.

Information about the location and size of windows in the web-page layout for the TV video content is received by PC system 100 via the Internet connection and forwarded from PC processor 104 to device processor 112 via data connection 114.

Any control signals for updating or refreshing the web-page layout are embedded in the TV signals received by PC system 100 from the TV source and transmitted from device processor 112 to PC processor 104 via data connection 114.

The present invention is not so limited. Alternatively or in addition, the following characteristics may apply:

A web-browsing session may be initiated by the user instructing device processor 112 to tune to a TV channel whose TV signal is embedded with control signals that, when decoded and extracted from the TV signal and transmitted from device processor 112 to PC processor 104 via data connection 114, cause PC processor 104 to automatically launch the web-browsing session.

The Java script (or other suitable code) executed by PC processor 104 can be programmed to update and/or refresh the web-page layout automatically (e.g., with a specified periodicity) and independent of any control signals embedded in the TV signals.

Information about the location and size of windows in the web-page layout for the TV video content may be embedded directly into the TV signals themselves. In that case, device processor 112 extracts that information directly from the received TV signals and does not have to receive such information from PC processor 104.

In any case, because the selected TV signal(s) (e.g., just video content or both audio and video content) that are displayed on PC monitor 106 (and rendered on speakers 108) are received from the TV source via a high-bandwidth connection, such as a conventional TV connection, the limited bandwidth of a conventional Internet connection does not have be used for streaming media delivery of that content. Moreover, the TV video signals are displayed on a PC monitor which typically has higher video resolution than a conventional TV set, providing the present invention with advantages over current WebTV technology. Moreover, since the present invention can be implemented as a PC peripheral device, no complicated installation within the PC tower is required, thereby providing advantages over conventional PC-based tuner card technology.

The result is the advantageous combination of high-quality display of video signals with the rich environment for interactivity provided by conventional PCs with Internet access of web-based services. Applications for the present invention include, but are not limited to, the enhancement of show-associated chat rooms, show-associated e-commerce, show-associated advertising, specific commercial-associated e-commerce, couponing, and promotional offers.

Although the present invention has been described in the context of combining a digital video signal from a computer processor with a TV video signal to generate a combined digital video signal, where the TV video signal appears within a corresponding window in the original digital video signal, the present invention is not so limited. For example, in alternative implementations of the present invention, the digital video signal from a computer processor may appear within a region of the TV video signal or the two video signals may appear adjacent one another in the combined digital video signal.

Although the present invention has been described in the context of TV signals having audio and video content, the present invention could also be implemented in the context of the audio content of other types of media signals, such as radio signals.

Although the present invention has been described in the context of a web site accessible via an Internet connection, it will be understood that the present invention may be implemented in the context of networks other than the Internet and the world wide web, including, for example, local area networks, wide area networks, intranets, and other internets.

The present invention may be implemented as circuit-based processes, including possible implementation on a single integrated circuit. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1. A computer peripheral device configurable between a computer processor and a computer monitor, the device comprising:
(a) a video input interface configured to receive a digital video signal from the computer processor;
(b) a television (TV) interface configured to receive at least one TV signal from a TV source;
(c) a device processor configured to combine the digital video signal and a TV video signal from each TV signal to generate a combined digital video signal; and
(d) a video output interface configured to transmit the combined digital video signal to the computer monitor.

2. The invention of claim 1, wherein each TV video signal appears within a corresponding window in the digital video signal.

3. The invention of claim 2, wherein the device processor automatically modifies one or more dimensions of each TV video signal based on dimensions of the corresponding window in the digital video signal.

4. The invention of claim 3, wherein the device further comprises a data interface configured to communicate with the computer processor, wherein the device processor receives location and the dimensions of the corresponding window from the computer processor via the data interface.

5. The invention of claim 3, wherein the device processor automatically determines location and the dimensions of the corresponding window by analyzing the digital video signal received from the computer processor.

6. The invention of claim 5, wherein the device processor determines the location and the dimensions of the corresponding window based on a specified keying signal for the window.

7. The invention of claim 1, wherein the device further comprises:
(e) an audio input interface configured to receive one or more audio signals from the computer processor, wherein the device processor is configured to combine the one or more audio signals with one or more TV audio signals from the at least one TV signal to generate one or more combined audio signals; and
(f) an audio output interface configured to transmit the one or more combined audio signals to one or more computer speakers.

8. The invention of claim 1, wherein the digital video signal received from the computer processor corresponds to a web-page layout accessed from a web site by a web browser implemented on the computer processor and each TV video signal is overlayed over a corresponding window in the web-page layout.

9. The invention of claim 8, wherein the device further comprises a data interface configured to communicate with the computer processor.

10. The invention of claim 9, wherein the device processor extracts data from at least one TV signal and transmits the extracted data to the computer processor via the data interface, wherein the extracted data comprises at least one message used by the web browser to access an updated web-page layout.

11. The invention of claim 9, wherein the device processor receives information relating to location and dimensions of each window in the web-page layout from the computer processor.

12. The invention of claim 9, wherein the device processor extracts information relating to location and dimensions of each window in the web-page layout from the at least one TV signal.

13. At a web site server in a computer network, a computer-implemented method comprising the steps of:
(a) generating signals corresponding to a web site supported by the web site server; and
(b) transmitting the signals from the web site server to a computer processor in the computer network, wherein the signals comprise:
(1) a digital video signal corresponding to the web site; and
(2) instructions for implementation by the computer processor for coordinating combination of the digital video signal corresponding to the web site with at least one TV signal from a TV source into a combined digital video signal.

14. The invention of claim 13, wherein the digital video signal corresponding to the web site is combined with the at least one TV signal by a computer peripheral device configured to:
(i) receive the digital video signal corresponding to the web site from the computer processor;
(ii) receive the at least one TV signal from the TV source; and
(iii) transmit the combined digital video signal to a computer monitor.

15. The invention of claim 14, wherein each TV video signal appears within a corresponding window in the digital video signal corresponding to the web site.

16. The invention of claim 15, wherein the computer peripheral device automatically modifies one or more dimensions of each TV video signal based on dimensions of the corresponding window in the digital video signal corresponding to the web site.

17. The invention of claim 16, wherein the computer peripheral device receives location and the dimensions of the corresponding window from the computer processor.

18. The invention of claim 16, wherein the computer peripheral device automatically determines location and the dimensions of the corresponding window by analyzing the digital video signal corresponding to the web site received from the computer processor.

19. The invention of claim 18, wherein the computer peripheral device determines the location and the dimensions of the corresponding window based on a specified keying signal for the window.

20. The invention of claim 16, wherein the computer peripheral device extracts information relating to location and the dimensions of the corresponding window from the at least one TV signal.

21. The invention of claim 14, wherein the computer peripheral device is further configured to:
(iv) receive one or more audio signals corresponding to the web site from the computer processor, wherein the computer peripheral device is configured to combine the one or more audio signals corresponding to the web site with one or more TV audio signals from the at least one TV signal to generate one or more combined audio signals; and
(v) transmit the one or more combined audio signals to one or more computer speakers.

22. The invention of claim 14, wherein the computer peripheral device extracts data from at least one TV signal and transmits the extracted data to the computer processor, wherein the extracted data comprises at least one message used by the computer processor to access an updated web-page layout from the web site server.
